(19) United States
(12) Patent Application Publication
(10) Pub. No.: US 2011/0090037 A1
(43) Pub. Date: Apr. 21, 2011

(54) TRANSFORMER STRUCTURE

(75) Inventors: Hsin-Wei Tsai, Taoyuan Hsien (TW); Yi-Lin Chen, Taoyuan Hsien (TW)

(73) Assignee: DELTA ELECTRONICS, INC., Taoyuan Hsien (TW)

(21) Appl. No.: 12/904,875

(22) Filed: Oct. 14, 2010

(30) Foreign Application Priority Data
Oct. 15, 2009 (TW) 098134997

(51) Int. Cl. H01F 27/28

(52) U.S. Cl. 336/220

(57) ABSTRACT

A transformer includes a bobbin, a primary winding coil, a secondary winding coil, a cover member and a magnetic core assembly. The bobbin includes a main body and a channel running through the main body. The main body includes a first winding section, a second winding section and a first coupling part. The primary winding coil is wound around the first winding section of the main body of the bobbin. The secondary winding coil is wound around the second winding section of the main body of the bobbin. The cover member is placed over the bobbin for partially sheltering the bobbin. The cover member has a second coupling part corresponding to the first coupling part. The magnetic core assembly is partially accommodated within the channel of the bobbin.

### FIELD OF THE INVENTION

The present invention relates to a transformer, and more particularly to a transformer having an increased electrical safety distance between the winding coil and the magnetic core assembly.

### BACKGROUND OF THE INVENTION

A transformer has become an essential electronic component for voltage regulation into required voltages for various kinds of electric appliances. Referring to FIG. 1, a schematic exploded view of a conventional transformer is illustrated. The transformer 1 comprises a bobbin 11, a cover member 12 and a magnetic core assembly 13. A primary winding coil 111 and a secondary winding coil 112 are wound around the bobbin 11. The outlet parts 113 and 114 of the primary winding coil 111 and the secondary winding coil 112 are respectively wound around and soldered on the pins 115, which are protruded from the bottom of the bobbin 11. The cover member 12 is used for partially sheltering the upper portion of the bobbin 11 in order to increase the creepage distances between the primary winding coil 111, the secondary winding coil 112 and the magnetic core assembly 13. The magnetic core assembly 13 includes middle portions 131 and leg portions 132. The middle portions 131 are accommodated within a channel 116 of the bobbin 11. The bobbin 11 is partially enclosed by the leg portions 132. As a consequence, the transformer 1 is assembled.

Please refer to FIG. 1 again. The cover member 12 has extension parts 121, which are respectively extended from the front end and the rear end of the cover member 12. The extension parts 121 could extend the length of the cover member 12. After the cover member 12 is placed over the bobbin 11 to shelter the bobbin 11, the creepage distances between the primary winding coil 111, the secondary winding coil 112 and the magnetic core assembly 13 are also increased. The use of the cover member 12, however, still has some drawbacks. For example, the extension parts 121 of the cover member 12 increase the overall volume of the transformer 1. In addition, after the cover member 12 is placed over the bobbin 11 to shelter the bobbin 11, the temperatures of the primary winding coil 111 and the secondary winding coil 112 are readily increased because the heat-dissipating path is hindered by the cover member 12.

### SUMMARY OF THE INVENTION

It is an object of the present invention to provide a transformer having an increased electrical safety distance between the winding coil and the magnetic core assembly.

Another object of the present invention provides a transformer having enhanced heat-dissipating efficacy and reduced operating temperature without the need of increasing the volume of the transformer.

In accordance with an aspect of the present invention, there is provided a transformer. The transformer includes a bobbin, a primary winding coil, a secondary winding coil, a cover member and a magnetic core assembly. The bobbin includes a main body and a channel running through the main body. The main body includes a first winding section, a second winding section and a first coupling part. The primary winding coil is wound around the first winding section of the main body of the bobbin. The secondary winding coil is wound around the second winding section of the main body of the bobbin. The cover member is placed over the bobbin for partially sheltering the bobbin. The cover member has a second coupling part corresponding to the first coupling part. The magnetic core assembly is partially accommodated within the channel of the bobbin.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic exploded view of a conventional transformer;

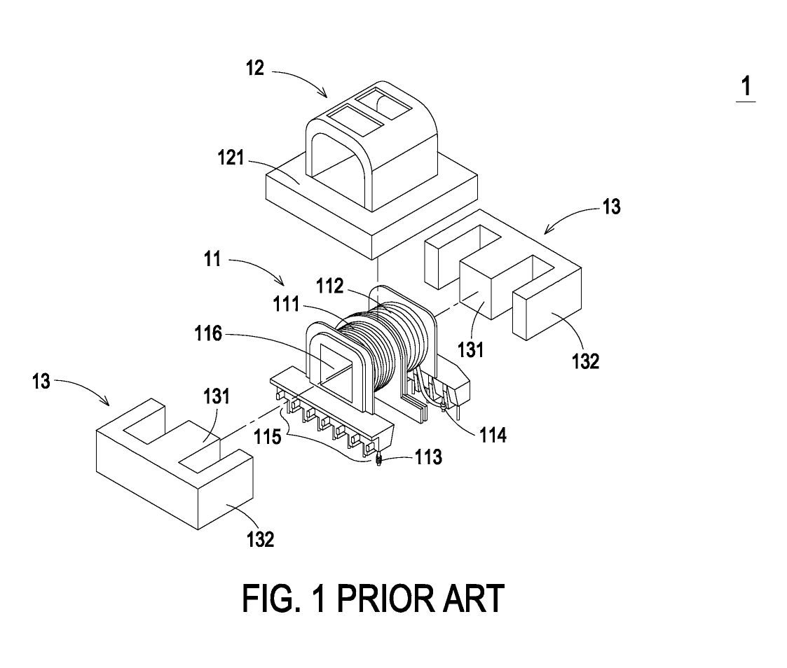

FIG. 2A is schematic exploded view illustrating a transformer according to an embodiment of the present invention;

FIG. 2B is schematic upside-down exploded view illustrating the transformer of FIG. 2A;

FIG. 2C is schematic exploded view illustrating a transformer according to another embodiment of the present invention;

FIG. 3A is schematic assembled view illustrating the transformer of FIG. 2A; and

FIG. 3B is schematic upside-down assembled view illustrating the transformer of FIG. 3A.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

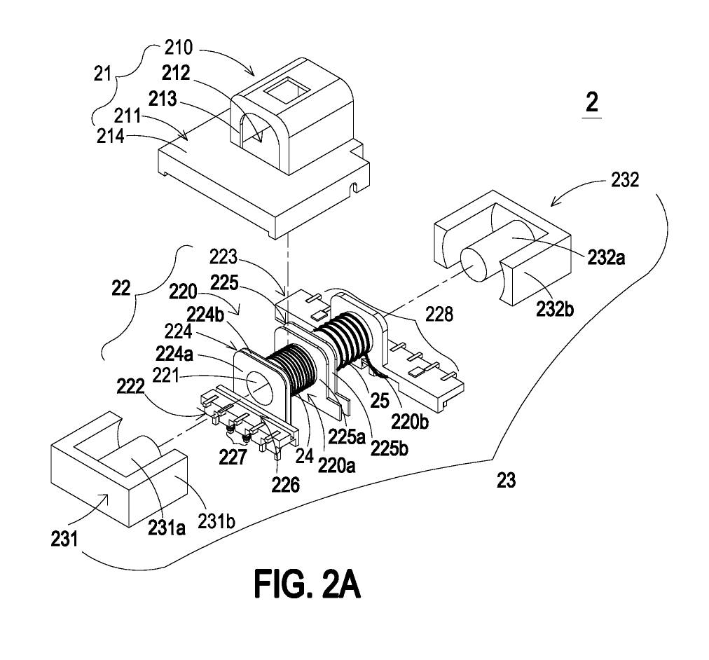

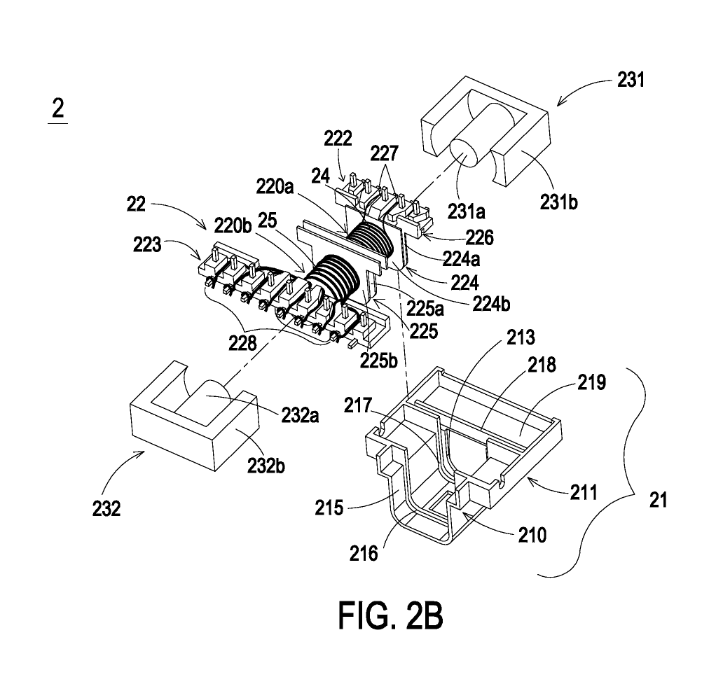

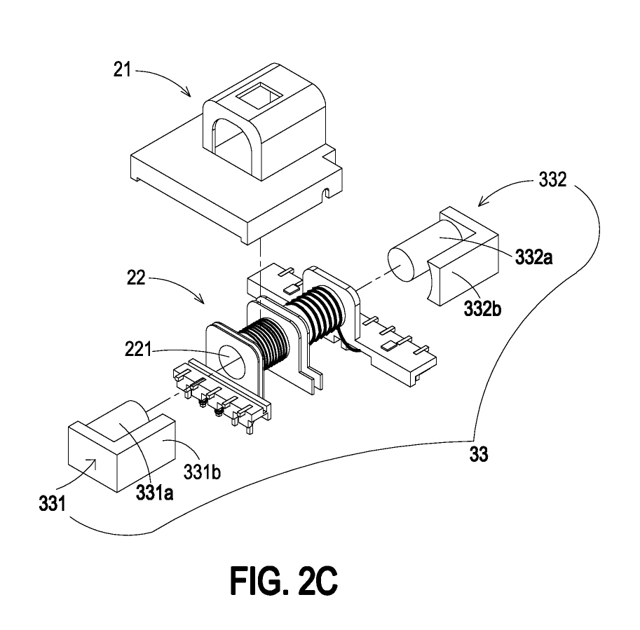

FIG. 2A is schematic exploded view illustrating a transformer according to an embodiment of the present invention. As shown in FIG. 2A, the transformer 2 comprises a cover member 21, a bobbin 22, a magnetic core assembly 23, a primary winding coil 24 and a secondary winding coil 25. The cover member 21 is combined with the bobbin 22. The cover member 21 comprises a first covering portion 210 and a second covering portion 211. The bobbin 22 comprises a main body 220 and a channel 221. The channel 221 runs through the main body 220. The main body 220 comprises a first winding section 220a, a second winding section 220b and a first coupling part 224. The magnetic core assembly 23 includes a first magnetic part 231 and a second magnetic part 232.

Please refer to FIG. 2A again. The first covering portion 210 is disposed at a higher level than the second covering portion 211 with respect to the bottom of the cover member 21. The first covering portion 210 has a receptacle 212 and an opening 213. The receptacle 212 is used for partially accommodating the bobbin 22. The opening 213 is aligned with the channel 221 of the bobbin 22. The second covering portion 211 has a first surface 214. The opening 213 is connected to the first surface 214 of the second covering portion 211.

The primary winding coil 24 is wound around the first winding section 220a of the main body 220 of the bobbin 22. The secondary winding coil 25 is wound around the second winding section 220b of the main body 220 of the bobbin 22. A first connecting base 222 and a second connecting base 223 are respectively disposed at two opposite sides of the main body 220 of the bobbin 22. Plural first pins 227 are disposed on the first connecting base 222. Plural second pins 228 are disposed on the second connecting base 223. The first pins 227 and the second pins 228 are respectively connected with the primary winding coil 24 and the secondary winding coil 25.

The first coupling part 224 is disposed in the vicinity of the first winding section 220a. That is, the first coupling part 224 is disposed beside the primary winding coil 24. In this embodiment, the first coupling part 224 is a concave structure that is defined by a gap between a side plate 224a and a partition plate 224b. The partition plate 224b is sheathed around the main body 220. In other word, the gap between the side plate 224a and the partition plate 224b are collectively formed into the concave structure of the first coupling part 224.

FIG. 2B is schematic upside-down exploded view illustrating the transformer of FIG. 2A. Please refer to FIGS. 2A and 2B. Corresponding to the first coupling part 224, the cover member 21 further includes a second coupling part 217. In this embodiment, the second coupling part 217 is a convex structure (or a slab). The second coupling part 217 is formed on an inner wall 215 of the first covering portion 210 of the cover member 21 and aligned with the first coupling part 224. During the process of combining the cover member 21 with the bobbin 22, the second coupling part 217 is just inserted into the concave structure of the first coupling part 224. Due to the engagement between the first coupling part 224 of the bobbin 22 and the second coupling part 217 of the cover member 21, the creepage distance between the primary winding coil 24 and the first magnetic part 231 is extended along the first coupling part 224 and the second coupling part 217.

Please refer to FIGS. 2A and 2B again. The bobbin 22 further comprises a third coupling part 225. The third coupling part 225 is arranged between the first winding section 220a and the second winding section 220b. In this embodiment, the third coupling part 225 is also a concave structure that is defined by a gap between two partition plates 225a and 225b. Corresponding to the third coupling part 225, the cover member 21 further includes a fourth coupling part 216. In this embodiment, the fourth coupling part 216 is a convex structure (or a slab) mating with the concave structure of the third coupling part 225. During the process of combining the cover member 21 with the bobbin 22, the fourth coupling part 216 is just inserted into the concave structure of the third coupling part 225. As a consequence, the creepage distance between the primary winding coil 24 and the secondary winding coil 25 is extended along the concave structure of the third coupling part 225.

Please refer to FIGS. 2A and 2B again. The first connecting base 222 of the bobbin 22 further comprises a fifth coupling part 226. In this embodiment, the fifth coupling part 226 is a recess and arranged in the vicinity of the side plate 224a. Corresponding to the fifth coupling part 226, the cover member 21 further includes a sixth coupling part 218. The sixth coupling part 218 is formed on an inner wall 219 of the second covering portion 211 of the cover member 21 and aligned with the fifth coupling part 226. In this embodiment, the sixth coupling part 218 is a protrusion mating with the recess of the fifth coupling part 226. During the process of combining the cover member 21 with the bobbin 22, the sixth coupling part 218 is inserted into the recess of the fifth coupling part 226. As a consequence, the creepage distance between the primary winding coil 24 and the first magnetic part 231 is further extended without the need of increasing the length of the cover member 21 or the length of the bobbin 22. In other words, the overall volume of the transformer 2 is reduced when compared with the prior art.

Please refer to FIG. 2A again. The first magnetic part 231 of the magnetic core assembly 23 comprises a middle portion 231a and two leg portions 231b. The second magnetic part 232 of the magnetic core assembly 23 also comprises a middle portion 232a and two leg portions 232b. The first magnetic part 231, the second magnetic part 232, the cover member 21 and the bobbin 22 are combined together to assemble the transformer 2. In this embodiment, the first magnetic part 231 and the second magnetic part 232 are E cores, so that the magnetic core assembly 23 is an EE-type magnetic core assembly. In another embodiment, the first magnetic part 331 and the second magnetic part 332 of the magnetic core assembly 33 are U cores, so that the magnetic core assembly 33 is a UU-type magnetic core assembly (see FIG. 2C). As shown in FIG. 2C, the first magnetic part 331 of the magnetic core assembly 33 comprises a middle portion 331a and a leg portions 331b; and the second magnetic part 332 of the magnetic core assembly 33 also comprises a middle portion 332a and a leg portion 332b. For combining the UU-type magnetic core assembly with the bobbin 22, the cover member 21 is placed over the bobbin 22. Afterwards, the middle portions 331a are accommodated within the channel 221 of the bobbin 22, and thus the transformer 2 is assembled.

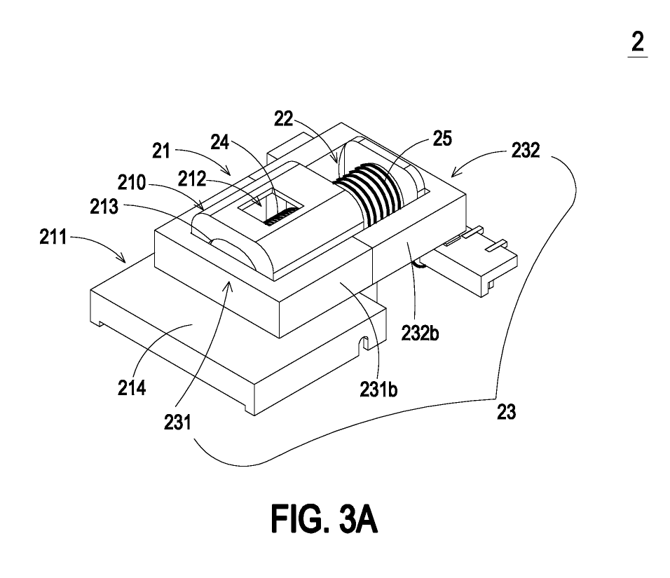

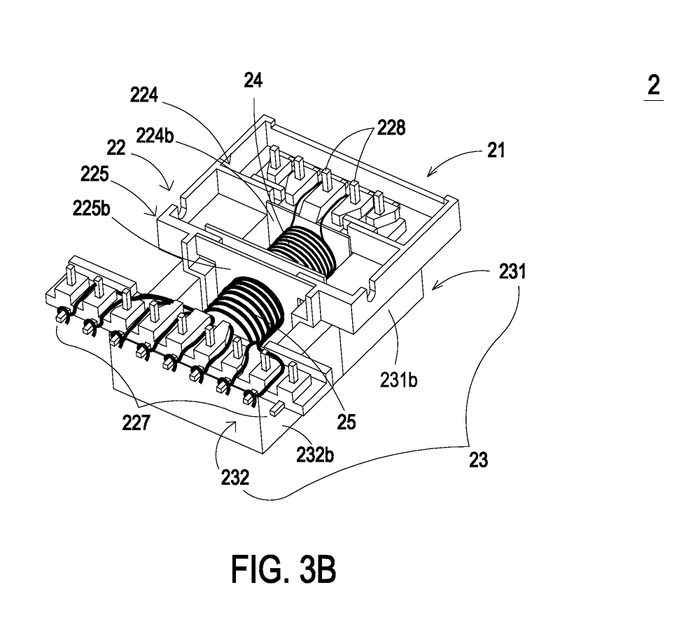

FIG. 3A is schematic assembled view illustrating the transformer of FIG. 2A. FIG. 3B is schematic upside-down assembled view illustrating the transformer of FIG. 3A. Hereinafter, a process of assembling the transformer 2 will be illustrated with reference to FIGS. 3A and 3B. First of all, the cover member 21 is placed over the bobbin 22 such that the bobbin 22 is at least partially sheltered by the first covering portion 210 of the cover member 21. In this embodiment, the primary winding coil 24 wound around the bobbin 22 is sheltered by the cover member 21 but the secondary winding coil 25 is exposed. Alternatively, the primary winding coil 24 and the secondary winding coil 25 could be both sheltered by the cover member 21. Next, the middle portion 231a of the first magnetic part 231 of the magnetic core assembly 23 is penetrated through the opening 213 of cover member 21 and inserted into the channel 221 of the bobbin 22 (see FIG. 2A). In addition, the leg portions 231b of the first magnetic part 231 are supported by the first surface 214 of the second covering portion 211 of the cover member 21. Next, the middle portion 232a of the second magnetic part 232 is inserted into the channel 221 of the bobbin 22. In addition, the leg portions 232b are supported on the second connecting base 223, so that the bobbin 22 is partially enclosed by the leg portions 232b. Meanwhile, the transformer 2 is assembled. Since the heat-dissipating path of the secondary winding coil 25 is no longer hindered by the cover member 21, the heat-dissipating efficacy of the transformer 2 is enhanced. Under this circumstance, the operating temperature of the transformer 2 is reduced.

Please refer to FIG. 3B again. After the cover member 21 is combined with the bobbin 22, the first coupling part 224 of the bobbin 22 is engaged with the second coupling part 217 of the cover member 21 (see FIG. 2A). As a consequence, the creepage distance between the primary winding coil 24 and the first magnetic part 231 is extended along the partition plate 224b and the side plate 224a (see FIG. 2A). In other words, the creepage distance between the primary winding coil 24 and the magnetic core assembly 23 is increased without the need of increasing the volume of the transformer 2. Moreover, due to the engagement between the third coupling part 225 of the bobbin 22 and the fourth coupling part 216 of the cover member 21 (see FIG. 2A), the creepage distance between the primary winding coil 24 and the secondary winding coil 25 is extended and thus the electrical safety distance between the primary winding coil 24 and the secondary winding coil 25 is maintained.

From the above description, the creepage distance between the primary winding coil and the secondary winding coil and the creepage distance between the primary winding coil, the secondary winding coil and the magnetic core assembly are increased due to the engagement between complementary coupling parts of the bobbin and the cover member. As a consequence, the electrical safety distance is increased without the need of increasing the volume of the transformer. Moreover, the bobbin is partially sheltered by the cover member. Since the heat-dissipating path of the secondary winding coil is no longer hindered by the cover member, the heat-dissipating efficacy of the transformer is enhanced and the operating temperature of the transformer is reduced.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer comprising:
a bobbin comprising a main body and a channel running through said main body, wherein said main body comprises a first winding section, a second winding section and a first coupling part;
a primary winding coil wound around said first winding section of said main body of said bobbin;
a secondary winding coil wound around said second winding section of said main body of said bobbin;
a cover member placed over said bobbin for partially sheltering said bobbin, wherein said cover member has a second coupling part corresponding to said first coupling part; and
a magnetic core assembly partially accommodated within said channel of said bobbin.

2. The transformer according to claim 1 wherein said cover member is placed over said bobbin for partially sheltering said primary winding coil.

3. The transformer according to claim 1 wherein said cover member comprises:
a first covering portion comprising a receptacle and an opening, wherein said bobbin is at least partially accommodated within said receptacle and said opening is in communication with said channel of said bobbin; and
a second covering portion.

4. The transformer according to claim 3 wherein said second coupling part is formed on an inner wall of said first covering portion of said cover member and in the vicinity of said opening of said first covering portion.

5. The transformer according to claim 1 wherein said first coupling part is disposed in the vicinity of said first winding section.

6. The transformer according to claim 1 wherein said first coupling part is a concave structure, and said second coupling part is a convex structure mating with said concave structure.

7. The transformer according to claim 6 wherein said concave structure is defined by a side plate and a partition plate, and said partition plate is sheathed around said main body.

8. The transformer according to claim 7 wherein said convex structure is a slab engaged with said concave structure, so that a creepage distance between said primary winding coil and/or said secondary winding coil and said magnetic core assembly is increased.

9. The transformer according to claim 1 wherein said main body further comprises a third coupling part, which is arranged between said first winding section and said second winding section.

10. The transformer according to claim 9 wherein said cover member further has a fourth coupling part corresponding to said third coupling part.

11. The transformer according to claim 10 wherein said third coupling part is a concave structure defined by two partition plates that are sheathed around said main body, and said fourth coupling part is a convex structure engaged with said concave structure of said third coupling part, so that a creepage distance between said primary winding coil and said secondary winding coil is increased.

12. The transformer according to claim 1 wherein a first connecting base and a second connecting base are respectively disposed at two opposite sides of said main body of said bobbin.

13. The transformer according to claim 12 wherein said first connecting base further comprises a fifth coupling part.

14. The transformer according to claim 13 wherein said cover member further has a sixth coupling part corresponding to said fifth coupling part.

15. The transformer according to claim 14 wherein said fifth coupling part is a recess, and said sixth coupling part is a protrusion engaged with said recess, so that a creepage distance between said primary winding coil and/or said secondary winding coil and said magnetic core assembly is increased.

16. The transformer according to claim 12 wherein a plurality of first pins are disposed on said first connecting base, and a plurality of second pins are disposed on said second connecting base, wherein said first pins and said second pins are respectively connected with said primary winding coil and said secondary winding coil.

17. The transformer according to claim 1 wherein said magnetic core assembly comprises a first magnetic part and a second magnetic part, wherein each of said first magnetic part and said second magnetic part includes a middle portion and at least one leg portion.

18. The transformer according to claim 1 wherein said magnetic core assembly is an EE-type magnetic core assembly.

19. The transformer according to claim 1 wherein said magnetic core assembly is a UU-type magnetic core assembly.
